(19) United States
(12) Patent Application Publication
(10) Pub. No.: US 2005/0216370 A1
(43) Pub. Date: Sep. 29, 2005

(54) Method for using a recovery trend parameter to determine an optimal forecast date

(75) Inventors: J.L. (Jen-Lin) Chao, Hsin Chu (TW); J.Y. (Jin-Yee) Lee, Taipei (TW); C.S. (Chao-Shim) Lin, Maio-Li (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/791,605

(22) Filed: Mar. 1, 2004

(51) Int. Cl. G06F 17/60; G06F 19/00

(52) U.S. Cl. 705/28

(57) ABSTRACT

The present invention discloses a method of modifying a production forecast in a fabrication facility using an optimal dynamic recovery trend parameter by performing the steps of: determining a plurality of PODs; determining a total accuracy of a plurality of recovery trend parameters used to predict each POD; performing a regression analysis on a generated recovery trend parameter accuracy graph; and determining an optimal recovery trend using an associated recovery trend accuracy curve.

### FIELD OF THE INVENTION

The present invention discloses a method of modifying a production forecast in a fabrication facility using an optimal dynamic recovery trend parameter.

### BACKGROUND

In an automated manufacturing facility, it is important to dynamically fulfill a customer's product order within a customer requested due date. This need increases in importance in manufacturing facilities produce large volumes of advanced technology products such as a wafer or semiconductor manufacturing facility. In such a volatile business as wafer fabrication facility it is important to fulfill a customer order as close to a customer's requested due date as possible to avoid customer dissatisfaction in an ever increasing competitive market.

Typically, existing order promising systems within a wafer fabrication facility do not have the capability to accurately fulfill a customer's order on a customer requested date or within a time period that a customer requests. Instead, forecasts are generated to predict future order demands. However, the forecasts are not based on real-time events relating to facility operations, but instead are based on past practices, data and experiences of facility operations and facility personnel. Existing forecasting systems do not provide a dynamic feedback system to determine allocated capacity and constraints within a manufacturing facility. Thus, using an existing system a fabrication facility's processing capacity cannot be fully utilized in an efficient manner.

In mass product assembly facilities, it is important to have a forecasted master production schedule that can forecast shipping dates or push out dates for fabricated products to be shipped to customers in a timely manner. In ideal world, an actual shipping date for a product fabricated in a fabrication or manufacturing facility is the same as the forecasted shipping date. However, in reality, many factors can negatively affect production and facility efficiency, thus delaying shipping dates of fabricated products. Additionally, high priority products being manufactured may upset the fabrication flow within a fabrication facility by causing a rushed delivery of certain products and by slowing down production of other products.

Production timing is critically important in a precise automated facility such as a wafer production facility or a semi-conductor fabrication facility (FAB). Typically, in a wafer manufacturing facility, a push out date or shipping date for a lot of wafers is calculated by using a fixed or constant efficiency or turn rate for all products produced within the FAB. However, when a batch of wafers or a lot of wafers is given a constant high priority processing time, wherein a lot of wafers is typically 25 wafers, then a fixed high priority turn rate is used to decrease the production time required of high priority lots.

The use of a both a fixed turn rate and a fixed high priority turn rate often results in discrepancies between an MPS forecasted shipping date and an actual shipping rate because, in reality, a FAB's turn rate is not a fixed value but fluctuates over time depending on facility conditions.

Therefore, it is desirable to provide a method of dynamically modifying a turn rate within a fabrication facility to generate an accurate modified forecast.

### SUMMARY OF THE INVENTION

The present invention modifies the forecast and more particularly, the turn rate, by using past performance data with respect to the forecast to develop a recovery trend. The recovery trend is dynamic and is frequently updated in accordance with the needs of the facility. Preferably, the recovery trend is updated on a weekly basis.

In accordance with a preferred embodiment of the present invention a method of modifying a forecast in a fabrication facility is disclosed. The method has the step of: using previously determined fabrication performance data to develop a recovery trend parameter, wherein the recovery trend parameter operates to modify pre-defined efficiency value of the fabrication facility to generate an accurate push out date for fabricated products fabricated within the fabrication facility.

In accordance with another preferred embodiment of the present invention, a method of determining an optimal recovery trend to generate at least one push out date is disclosed. The method has the steps of: a) determining a plurality of POD dates from a pre-defined system date until an actual shipping date for each lot being processed within the facility occurs using a plurality of variables selected from a current system date, a number of remaining days, a turn rate, and a recovery trend parameter, wherein the formula used to calculate each of the POD dates equals current system date+(remaining days*( turn rate+recovery trend)); b) determining a total accuracy of each recovery trend parameter used to predict an accurate POD associated with all associated lots upon shipping a plurality of lots associated with an order to at least one customer during an associated shipping date; c) performing a regression analysis on a generated recovery trend parameter accuracy graph to generate an associated recovery trend parameter accuracy curve; and d) determining an optimal recovery trend using the associated recovery trend accuracy curve.

In accordance with another preferred embodiment of the present invention, a method of determining an optimal recovery trend is disclosed. The method of determining an optimal recovery trend has the steps of: a) determining a plurality of POD dates from a pre-defined system date until an actual shipping date for each lot being processed within the facility occurs; b) verifying the accuracy of each of a plurality of determined recovery trend parameters used to determine each of the plurality of POD dates; c) determining a total accuracy of each recovery trend parameter used to predict a correct POD for all associated lots upon shipping a plurality of lots associated with an order to at least one customer during an associated shipping date; d) generating a recovery trend parameter accuracy graph; e) performing a regression analysis on the generated recovery trend parameter accuracy graph to generate an associated recovery trend parameter accuracy curve; f) determining an optimal recovery trend using the associated recovery trend accuracy curve.

### BRIEF DESCRIPTION OF THE DRAWINGS

FIG. 1 is a flowchart illustrating a preferred method of modifying a production forecast in a fabrication facility using an optimal dynamic recovery trend parameter in accordance with a preferred embodiment of the present invention.

FIG. 2 is a chart used to associate a wafer lot with a plurality of push out dates and with a plurality of recovery trend parameters in accordance with a preferred embodiment of the present invention.

FIG. 3 is a chart used to associate a wafer lot with a plurality of push out dates and with a plurality of recovery trend parameters in accordance with a preferred embodiment of the present invention.

FIG. 4 is a chart used to associate a wafer lot with a plurality of push out dates and with a plurality of recovery trend parameters in accordance with a preferred embodiment of the present invention.

FIG. 5 is a graph illustrating a recovery trend parameter accuracy curve in accordance with a preferred embodiment of the present invention.

### DETAILED DESCRIPTION OF THE PREFERRED EMBODIMENTS

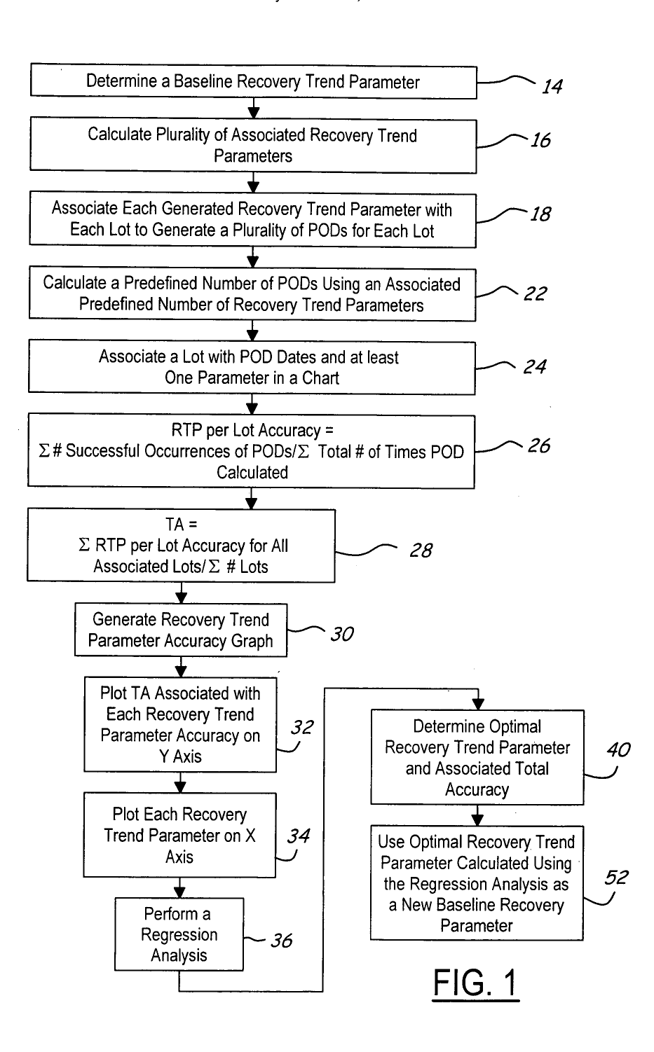

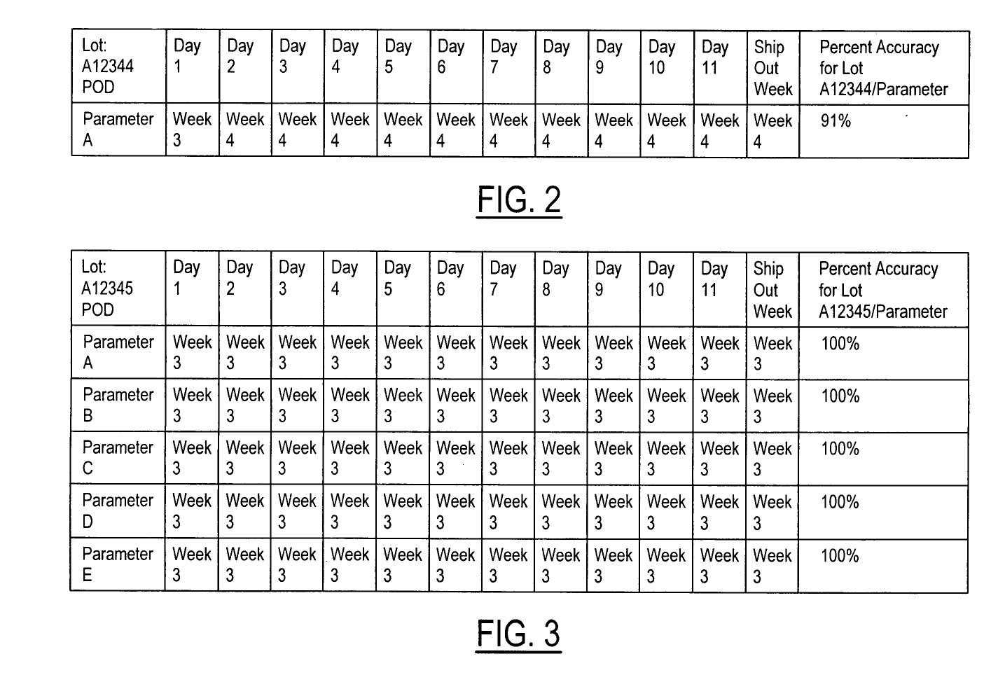

Referring now to the drawings, as shown in FIG. 1, the present invention provides a method 10 to modify a forecast in a fabrication facility and more particularly, a turn rate, by using past performance data with respect to the forecast to develop a recovery trend. The recovery trend is dynamic and is frequently updated in accordance with the needs of the facility. Preferably, the recovery trend is updated on a weekly basis. The recovery trend equals a number of recovery days (RD) divided by a number of remaining days (RMD) plus the number of recovery days (RD/(RMD+RD)), wherein the recovery days are a number of additional days needed to process a lot beyond an originally forecasted shipping date, and wherein the remaining days are the number of days between a current date of processing a lot within an order and an originally forecasted or pre-defined shipping date.

The turn rate indicates the efficiency of the fabrication facility, wherein the turn rate is the ratio of actual products produced in the production facility to forecasted products produced in the fabrication facility. Preferably, the fabrication facility is a wafer fabrication facility such as a semiconductor wafer fabrication facility. Also preferably, the products produced are wafers disposed within a plurality of wafer lots, wherein a lot of wafers is typically 25 wafers, and wherein a plurality of lots are fabricated to produce a total number of wafers within a wafer order to be shipped to a customer.

The method 10 of the present invention may be performed by using a database system, wherein the database system has a plurality of push out date (POD) or forecasted shipping date records associated with each lot. In a normal semiconductor Fab, approximately 400 lots are shipped each week. Using data relating to the 400 lots provides a large sample size for performing a statistical analysis of the fabrication facility efficiency and fabrication trends within the facility.

A dynamic recovery trend parameter may be determined by first determining a baseline recovery trend parameter using past-fabrication performance or history data (step 14). The recovery trend parameter is a variable that is calculated on a periodic basis, preferably during each week of fabricating a plurality of wafers associated with a customer wafer order, wherein the recovery trend parameter is then added to the turn rate to accurately predict the fabrication facility's efficiency.

In a preferred embodiment of the present invention, a baseline recovery trend parameter may be determined for an order of 400 lots ordered during an initial system date of Jun. 1, 2003. The forecasted POD based on a pre-defined output rate of 10 lots/day is calculated by dividing the total number of lots (400) by the output rate of 10 lots/day. Therefore, the forecasted POD date associated with an output rate of 10 lots/day is 40 days from Jun. 1, 2003, or Jul. 10, 2003. The 40 days are the originally forecasted remaining days. Each day of processing the 400 lots, the actual number of lots built may be compared with the forecasted number to determine the efficiency or turn rate of the facility.

For example, on day 30, the forecasted number of lots processed is 300 (10 (lots/day)*30 days). However the actual number of lots processed on day 30 is 280 lots, therefore, the difference between the forecasted lot order amount for the associated processing day 30 and the actual number of lots built on day 30 is 20 (300−280; ).

The accuracy of the forecast is 280/300=93%.

The difference between the forecasted lot order amount associated with a processing day and the number of lots actually processed on the associated processing day is then divided by the output rate to calculate the number of recovery days needed to actually complete the order. For example, the recovery days using the present example are calculated by dividing the difference (20 lots) between the forecasted lot order amount for the associated processing day 30 and the actual number of lots built on day 30 by the output rate (10 lots/day) as shown:
20 lots/10 lots/day=2 recovery days.

Thus, the recovery day calculation shows that 2 additional days will be needed to build the total order of 400 lots. The remaining days necessary to build all the lots from actual day 30 is the days between the last forecasted date and day 30 plus the number of recover days. For example, the original date was July 10, thus day 30 would be June 30, and the days between July 10 and June 30 equal 10 remaining days, plus two additional recovery days equals (10+2) or 12 days. The baseline recovery trend parameter (BRTP) may then calculated as shown:
BRTP=2 recovery days/12 remaining plus recovery days=0.17 days/day.

A plurality of associated recovery trend parameters are calculated or generated (step 16) upon determining a value for the initial baseline recovery trend parameter (step 14).

A plurality of recovery trend parameters are calculated from the baseline recovery trend parameter, wherein the baseline recovery trend parameter preferably represents an optimal recovery trend from a previous date for a lot that was processed in a similar way to a current lot in process. Preferably the previous date is a week, however, the previous date may be any pre-defined time period ranging from days to weeks to months.

A plurality recovery trend parameters are calculated as a statistical variation from the baseline recover trend parameter, wherein the statistical variation may be a standard deviation from the baseline value or alternatively, a factor added to or multiplied by the baseline recovery trend parameter. In another preferred embodiment, the baseline recovery trend parameter may vary from each of the plurality of recovery trend parameters by a constant value or a factor of a constant value, alternatively each of the plurality of recovery trend parameters may vary from the baseline recovery trend by a sigma variance. However, any conventional statistical variation may be used to calculate each of the plurality of recovery trend parameters using an optimal baseline recovery trend parameter.

In a preferred embodiment, each of the recovery trend parameters are preferably selected from the group of A, B, C, D, and E, wherein each generated recovery trend parameter is associated with each lot to generate a plurality of PODs for each lot (step 18). The five parameters specified herein are used for illustrative purposes only and should not be considered limiting of the number of recovery trend parameters that may be used to determine an optimal recovery trend. There is no maximum limit to the number of recovery trend parameters that may be used to determine an optimal recovery trend.

In a preferred embodiment of the present invention, a predefined baseline recovery trend (PBRT) is 0.15. The new recovery trend parameters calculated using the BRTP vary by a constant value of 0.02 multiplied by an integer ranging between −2<X<+2, wherein in recovery trend parameter D is 0.15+1*(0.02), recovery trend parameter E is 0.15+2*(0.02), recovery trend parameter B is 0.15−1*(0.02), and recovery trend parameter A is 0.15−2*(0.02).

Thus, in the preferred embodiment, each recovery trend parameter is calculated as a percentage or a sigma variance from the optimal previous recovery trend the formulas are as follows:

recovery trend parameter C+recovery trend parameter

C*X*10%, wherein X is an integer ranging between −2 and 2 (−2<X<2) multiplied by a percentage preferably 10%, such that X*10% ranges between +/−10 to +/−20%. Therefore,
Recovery trend parameter A is PBRT+PBRT*−2*10%
Recovery trend parameter B is PBRT+PBRT*−1*10%
Recovery trend parameter C is PBRT+PBRT*0*10%
Recovery trend parameter D is PBRT+PBRT*2*10%
Recovery trend parameter E is PBRT+PBRT*2*10%

Thus for each day of processing each lot until the lot is actually shipped, a pre-defined number of PODs are calculated using an associated pre-defined number of recovery trend parameters (step 22).

A plurality of POD dates are determined from a pre-defined system date until an actual shipping date for each lot being processed within the facility occurs (step 22). Thus, a POD is calculated for each day a lot associated with an order is being processed within a FAB facility using a plurality of variables selected from a current system date, a number of remaining days, a turn rate, and a recovery trend parameter (step 22). The current system date is a current date that an associated lot is being processed. The number of remaining days is the number of days estimated between the current system date and an originally forecasted due date based off of a master production schedule (MPS) forecast, wherein the number of recovery days are the number of days beyond an originally forecasted due date needed to complete an order when the actual production schedule varies from the MPS forecast. The turn rate is a pre-defined variable representing the ratio of: the actual number of lots processed per day divided by the forecasted number of lots processed per day. The recovery trend is a calculated variable used to modify the turn rate, wherein the recovery trend is equal to a number of recovery days divided by a number of remaining days plus the number of recovery days. The recovery trend is added to the forecasted turn rate to determine a modified turn rate.

The formula for calculating a POD is:
POD=current system date+(remaining days*( turn rate +recovery trend)), wherein the turn rate+recovery trend is the modified turn rate.

In a preferred embodiment, a plurality of PODs are calculated for a lot A12344, wherein the POD variables are defined as follows:
Current system date=day 1 (Friday, May 9, 2003)
Remaining days=10 days
recovery trend parameter A=−0.2 days/day
recovery trend parameter B=−0.3 days/day
recovery trend parameter C=+0.2 days/day turn rate=1.
POD 1 calculated using recovery trend parameter A: =current date/day 1 (Friday May 9, 2003)+10 days*(1−0.2 day/day)
=Friday May 9, 2003+8 days=Saturday May 17, 2003. Saturday May 17, 2003 is the third week of processing lot # A12344.
POD 2 calculated using recovery trend parameter A:
=day 2(Saturday May 10, 2003)+9 days*(1−0.2 day/day)
=Sunday May 18, 2003, wherein Sunday May 18, 2003 is in the fourth week of processing lot # A12345, and wherein 7.2 days is rounded up to 8 modified remaining days.
POD 3 using recovery trend parameter A:
=day 3 (May 11)+8*(1−0.2)=May 18, week 4
POD 4 using recovery trend parameter A:
=day 4 (May 13)+7*(1−0.2)=May 19, week 4
POD 5 using recovery trend parameter A=day 5 (May 14)+6*(1−0.2)=May 19, week 4
POD 6 using recovery trend parameter A=day 6 (May 15)+5*(1−0.2)=May 19, week 4
POD 7 using recovery trend parameter A=day 7 (May 16)+4*(1−0.2)=May 20, week 4
POD 8 using recovery trend parameter A=day 8 (May 17)+3*(1−0.2)=May 20, week 4
POD 9 using recovery trend parameter A=day 9 (May 18)+2*(1−0.2)=May 19, week 4
POD 10 using recovery trend parameter A=day 10 (May 19)+1*(1−0.2)=May 20, week 4
POD 11 using recovery trend parameter A=day 11 (May 20)+0*(1−0.2)=May 20, week 4

Once a lot within an order is shipped to a customer on a shipping date, then the success of using each recovery trend parameter to predict an accurate POD is determined. The date may be a specific day, or alternatively a range of days selected from a week, month, or year. Preferably, the shipping date is a week.

The success of using each recovery trend parameter to predict a correct POD may be determined by associating a lot with a plurality of POD dates and at least one parameter in a chart (step 24), wherein the chart for lot A12344 is shown in FIG. _2_, and wherein the lot A12344 is created using the calculated POD data as determined above. The FIG. _2_ chart shows that lot A12344 was actually shipped on week 4, using the recovery trend parameter of recovery trend parameter A=−0.2, the recovery trend parameter A was successful 10 times on Days 2-11 and failed 1 time on Day 1. Thus, 10 of the 11 PODs calculated using the recovery trend parameter −0.2 determined that the lot would be shipped during week 4.

Thus the accuracy of a recovery trend parameter (RTP) used to predict a correct POD for an associated lot upon shipping the lot to at least one customer (RTP per lot accuracy) (step 26) is verified or determined by summing the number of successful occurrences of PODs predicting an actual shipping date of an associated lot, wherein the PODs are calculated using an associated recovery trend parameter (# successful occurrences of PODS) and then dividing the # successful occurrences of PODs by the total number of times a POD is calculated using an associated recovery trend parameter for an associated lot (total # of times POD calculated) as follows:
RTP per lot accuracy=

# successful occurrences of PODs/total # of times POD calculated.

In a preferred embodiment: the number of successful occurrences of PODs predicting the actual shipping date of week 4 for the lot A12344 equals ten (10), wherein the PODs were calculated using recovery trend parameter A; and the total # of times a POD was calculated using the associated recovery trend parameter A for lot A12344 equals eleven (11).

Thus, the accuracy of the recovery trend parameter A for lot A12344, as shown in FIG. _2_ is:

10/11 or a 91% accuracy of recovery trend parameter A used to predict a correct POD for lot A12344.

In the preferred embodiment for determining the accuracy of the recovery trend for parameter A, only one recovery trend parameter is used, however, it is preferable to use a plurality of recovery trend parameters to determine the accuracy of predicting the correct POD using each of the plurality of associated recovery trend parameters for each associated lot.

The total accuracy (TA) of each recovery trend parameter used to predict an accurate POD for all associated lots upon shipping a plurality of lots associated with an order to at least one customer during an associated shipping date is determined (step 28). Each recovery trend parameter accuracy associated with each lot shipped on an associated shipping date are summed together (RTP per lot accuracy for all associated lots) and then divided by the total number of lots within a similarly processed order shipped on the associated shipping date (# lots) using the following formula:

TA=RTP per lot accuracy for all associated lots/# lots.

In a preferred embodiment of the present invention, five recovery trend parameters are specified as follows for a lot A12345 as follows:
Recovery trend parameter A=0.11
Recovery trend parameter B=0.13
Recovery trend parameter C=0.15
Recovery trend parameter D=0.17
Recovery trend parameter E=0.19

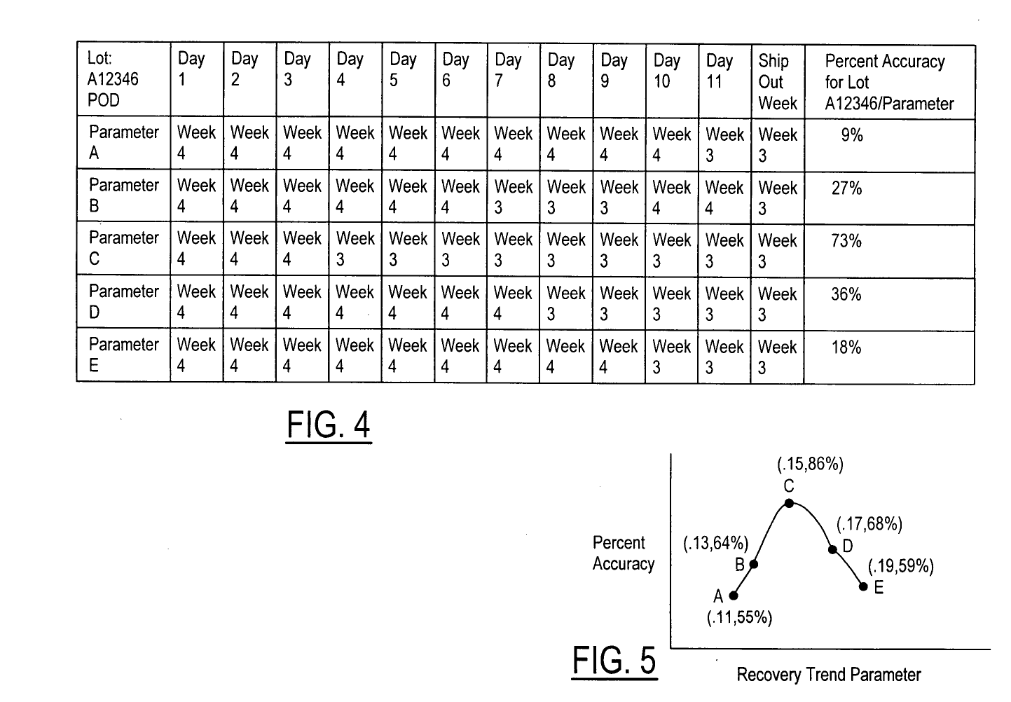

A plurality of PODs for the lots A12345 and A12346 are generated using the method of step 22 to generate two charts as shown in FIGS. 3-4, wherein the chart for lot A12345 shown in FIG. 3 associates the lot A12345 with each day of processing of an order and with each recovery trend parameter to determine a POD by recovery trend parameter and by date, wherein the date falls within a week, and wherein the chart for lot A12346 shown in FIG. 4 associates the lot A12346 with each day of processing of the lot and with each recovery trend parameter to determine a POD by recovery trend parameter and by date, wherein the date is a specified week.

As shown in FIG. 3, the lot A12345 was actually shipped during week three, and thus, each of the recovery trend parameters A, B, C, D, and E accurately predicted a POD date of week three. Each of the recovery trend parameters A, B, C, D, and E successfully predicted a POD of week 3 eleven (11) times out of the 11 total days that lot A12345 was processed, and thus, the RTP per lot accuracy for the lot A12345 associated with each parameter A, B, C, D, and E is 100%, respectively.

As shown in FIG. 4, the lot A12346 was actually shipped during week three.

The recovery trend parameter A used to predict a plurality of POD dates associated with lot A12346 successfully predicted week three, 2 times out of the 11 total days that lot A12346 was processed, therefore, the RTP per lot accuracy for the lot A12346 associated with parameter A was 2/11 or 9%.

The recovery trend parameter B used to predict a plurality of POD dates associated with lot A12346 successfully predicted week three, 3 times out of the 11 total days that lot A12346 was processed, therefore, the RTP per lot accuracy for the lot A12346 associated with parameter B was 3/11 or 27%.

The recovery trend parameter C used to predict a plurality of POD dates associated with lot A12346 successfully predicted week three, 8 times out of the 11 total days that lot A12346 was processed, therefore, the RTP per lot accuracy for the lot A12346 associated with parameter C was 8/11 or 73%.

The recovery trend parameter D used to predict a plurality of POD dates associated with lot A12346 successfully predicted week three, 4 times out of the 11 total days that lot A12346 was processed, therefore, the RTP per lot accuracy for the lot A12346 associated with parameter D was 4/11 or 36%.

The recovery trend parameter E used to predict a plurality of POD dates associated with lot A12346 successfully predicted week three, 2 times out of the 11 total days that lot A12346 was processed, therefore, the RTP per lot accuracy for the lot A12346 associated with parameter E was 2/11 or 9%.

The TA for parameter A is calculated by first adding the accuracy of parameter A associated with lot A12345 (100%) to the accuracy of parameter A associated with lot A12346 (9%), wherein the RTP per lot accuracy for parameter A equals 109% (100%+9%). Next, the number of lots shipped on the same week having a calculated POD using parameter A are summed, wherein # lots equals 2 (A12345, and A12346, respectively). The TA for parameter A (TAA) is determined by dividing RTP per lot accuracy for parameter A is divided by # lots as follows:
TAA=109%/2
55% accuracy for parameter A.

The TA for parameter B (TAB) is calculated by first adding the accuracy of parameter B associated with lot A12345 (100%) to the accuracy of parameter B associated with lot A12346 (27%), wherein the RTP per lot accuracy for parameter B equals 127% (100%+27%). Next, the number of lots shipped on the same week having a calculated POD using parameter B are summed, wherein # lots equals 2 (A12345, and A12346, respectively). The TAB is determined by dividing RTP per lot accuracy for parameter B is divided by # lots as follows:
TAB=127%/2
=64% accuracy for parameter B.

The TA for parameter C (TAC) is calculated by first adding the accuracy of parameter C associated with lot A12345 (100%) to the accuracy of parameter C associated with lot A12346 (73%), wherein the RTP per lot accuracy for parameter C equals 173% (100%+73%). Next, the number of lots shipped on the same week having a calculated POD using parameter C are summed, wherein # lots equals 2 (A12345, and A12346, respectively). The TAC is determined by dividing RTP per lot accuracy for parameter C is divided by # lots as follows:
TAC=173%/2
=87% accuracy for parameter C.

The TA for parameter D (TAD) is calculated by first adding the accuracy of parameter D associated with lot A12345 (100%) to the accuracy of parameter D associated with lot A12346 (36%), wherein the RTP per lot accuracy for parameter D equals 173% (100%+36%). Next, the number of lots shipped on the same week having a calculated POD using parameter D are summed, wherein # lots equals 2 (A12345, and A12346, respectively). The TAD is determined by dividing RTP per lot accuracy for parameter D is divided by # lots as follows:
TAD=136%/2
68% accuracy for parameter D.

The TA for parameter E (TAE) is calculated by first adding the accuracy of parameter E associated with lot A12345 (100%) to the accuracy of parameter E associated with lot A12346 (18%), wherein the RTP per lot accuracy for parameter E equals 173% (100%+18%). Next, the number of lots shipped on the same week having a calculated POD using parameter E are summed, wherein # lots equals 2 (A12345, and A12346, respectively). The TAE is determined by dividing RTP per lot accuracy for parameter E is divided by # lots as follows:
TAE=118%/2
59% accuracy for parameter E.

Step 4, 5 search and application:
Upon determining the TA associated with each recovery trend parameter, a graph is generated (step 30), wherein the TA associated with each recovery trend parameter is then plotted on a Y axis of a graph (step 32), and each associated recovery trend parameter having an associated Y axis TA is plotted on an X axis of a graph (step 34).

Next, a regression analysis is performed preferably to generate an associated recovery trend parameter accuracy curve (step 36). In a preferred embodiment, shown in FIG. 5, a recovery trend parameter accuracy graph is generated by plotting each TA associated with the parameters selected from A (9%), B (27%), C (73%), D (36%), and E (18%), respectively on the Y axis and each parameter A(0.11), B(0.13), C(0.15), D(0.17), and E(0.19).

Preferably, the regression analysis performed generates a polynomial formula F (x,y) using the plotted coordinates on the recovery trend parameter graph. The regression analysis may be performed by using any conventional statistical regression analysis method well-known in the statistical arts, wherein the regression analysis may be simply connecting the plotted points on the accuracy vs. recovery trend graph to best fit a curve (as shown in FIG. 5), or alternatively, the regression analysis may be performed using a computer program that generates a curve given any specified number of data points.

An optimal recovery trend parameter and associated total accuracy may be determined (step 40) by locating a maximum point on the curve, wherein the maximum point on the curve indicates a maximum total accuracy of an optimal recovery trend parameter, and wherein the optimal recovery trend parameter for the shipping week having the associated plotted recovery trend values may be determined by associating a maximum point on the Y axis of the curve with an associated point on the X axis of the curve. The optimal recovery trend parameter may also be determined by calculating the derivative of the polynomial formula F (x,y) or the tangent of the curve.

In the preferred embodiment as shown in FIG. ______ , the maximum point on the Y axis is approximately 88% and may be associated with a X axis value of approximately 0.16. This optimal recovery trend parameter calculated using the regression analysis may be used as a new baseline recovery parameter, wherein the new baseline recovery parameter is used to generate a plurality of new recovery trend parameters for a future date by repeating steps 16, 18, 20, 22, 24, 26, 28, 30, 32, 34, 36, 38, and 40 (step 42).

Selected points or slopes along the recovery trend parameter accuracy curve may be used to adjust a plurality of PODs when changes occur in the processing status of the fabrication facility or of a lot or order being processed. For example, if a high priority order or lot is introduced during processing, then an appropriate recovery trend parameter may be selected from the curve.=

From the foregoing, it should be appreciated that a method of modifying a production forecast in a fabrication facility using an optimal dynamic recovery trend parameter is provided.

1. A method of modifying a forecast in a fabrication facility comprising the steps of:
using previously determined fabrication performance data to develop a recovery trend parameter, wherein the recovery trend parameter operates to modify pre-defined efficiency value of the fabrication facility to generate an accurate push out date for fabricated products fabricated within the fabrication facility.

2. The method of claim 1, wherein the recovery trend parameter is dynamic.

3. The method of claim 1, wherein the pre-defined efficiency value of the fabrication facility is a turn rate, wherein the turn rate equals a ratio of actual products to forecasted products fabricated within the fabrication facility.

4. The method of claim 1, wherein the fabrication facility is a wafer fabrication facility, and wherein the products fabricated are wafers disposed within a plurality of wafer lots.

5. The method of claim 4, wherein the recovery trend parameter equals a number of recovery days divided by a number of remaining days plus the number of recovery days, wherein the recovery days are a number of additional days needed to process a lot beyond an originally forecasted shipping date, and wherein the remaining days are the number of days between a current date of processing a lot within an order and an originally forecasted shipping date.

6. The method of claim 1, further comprising the steps of:
determining a baseline recovery trend parameter.

7. The method of claim 1, wherein the baseline recovery trend parameter is used to determine a plurality of associated recovery trend parameters.

8. The method of claim 6, further comprising the steps of:
generating the plurality of associated recovery trend parameters by adding at least one multiple of a constant factor to the baseline recovery trend parameter; and
generating the plurality of associated recovery trend parameters by adding at least one multiple of a constant factor to the baseline recovery trend parameter.

9. The method of claim 6, further comprising the steps of:
generating a plurality of recovery trend parameters from a previous date by adjusting the baseline recovery trend parameter by a sigma variation.

10. A method of determining an optimal recovery trend to generate at least one push out date comprising the steps of:
a) determining a plurality of POD dates from a pre-defined system date until an actual shipping date for each lot being processed within the facility occurs using a plurality of variables selected from a current system date, a number of remaining days, a turn rate, and a recovery trend parameter, wherein the formula used to calculate each of the POD dates equals current system date+(remaining days*( turn rate+recovery trend));
b) determining a total accuracy of each recovery trend parameter used to predict an accurate POD associated with all associated lots upon shipping a plurality of lots associated with an order to at least one customer during an associated shipping date;
c) performing a regression analysis on a generated recovery trend parameter accuracy graph to generate an associated recovery trend parameter accuracy curve; and
d) determining an optimal recovery trend using the associated recovery trend accuracy curve.

11. The method of claim 10, wherein the step of determining an optimal recovery trend using the associated recovery trend accuracy curve comprises the step of:
locating a maximum point on the recovery trend accuracy curve, wherein the maximum point on the curve indicates a maximum total accuracy of an optimal recovery trend parameter, and wherein the optimal recovery trend parameter for the shipping week having the associated plotted recovery trend values is determined by further performing the step of associating a maximum point on the Y axis of the recovery trend accuracy curve with an associated point on the X axis of the recovery trend accuracy curve.

12. A method of determining an optimal recovery trend comprising the steps of:
a) determining a plurality of POD dates from a pre-defined system date until an actual shipping date for each lot being processed within the facility occurs;
b) verifying the accuracy of each of a plurality of determined recovery trend parameters used to determine each of the plurality of POD dates;
c) determining a total accuracy of each recovery trend parameter used to predict a correct POD for all associated lots upon shipping a plurality of lots associated with an order to at least one customer during an associated shipping date;
d) generating a recovery trend parameter accuracy graph;
e) performing a regression analysis on the generated recovery trend parameter accuracy graph to generate an associated recovery trend parameter accuracy curve;
f) determining an optimal recovery trend using the associated recovery trend accuracy curve.

13. The method of step 12 comprising the steps of:
calculating each of the plurality of POD dates using a plurality of variables selected from a current system date, a number of remaining days, a turn rate, and a recovery trend parameter, wherein the formula used to calculate each of the POD dates equals current system date+(remaining days*(turn rate+recovery trend)).

14. The method of claim 13, further comprising the step of:
determining a value for a baseline recovery trend parameter.

15. The method of claim 13, using the optimal recovery trend as a baseline recovery trend parameter for a future date.

16. The method of claim 14, further comprising the step of:
calculating a plurality of recovery trend parameters associated with each lot being processed using the baseline recovery trend parameter.

17. The method of claim 16, further comprising the steps of:
associating a lot with a plurality of calculated POD dates and with each of the plurality of recovery trend parameters to determine the success of using each recovery trend parameter to predict a correct POD.

18. The method of claim 12, further comprising the steps of:
plotting a total accuracy associated with each recovery trend parameter on a Y axis of the recovery trend parameter accuracy graph; and
plotting each associated recovery trend parameter having an associated total accuracy on an X axis of a graph.

19. The method of claim 12, comprising the step of:
repeating steps 12a)-e) upon completing step 12f).
